(19) United States
(12) Patent Application Publication
(10) Pub. No.: US 2009/0230709 A1
(43) Pub. Date: Sep. 17, 2009

(54) Home utility management vehicle mini van or Hum V Mini Van

(76) Inventor: Michael Lawrence Beauchamp, San Francisco, CA (US)

Correspondence Address: Michael Lawrence Beauchamp, #501, 285 Turk Street, San Francisco, CA, 94102, US

(21) Appl. No.: 12/075,610

(22) Filed: Mar. 13, 2008

(51) Int. Cl. B60J 5/06

(52) U.S. Cl. 296/1.04

(57) ABSTRACT

A large utility vehicle featuring a side sliding door and bottom-mounted scuff plate, occupant safety features, capable of high-speed performance, off-road, rough terrain transport, Motion-Pictures-taking, surveillance, pick-up, or/and rescue and other unique advantages for a new type utility vehicle.

### BACKGROUND OF THE INVENTION

1. Field of the Invention

This invention genesis pertains to occupant safety features, which for the first time enables occupants of a utility vehicle, sport utility vehicle, truck, van, passenger van, and, or mini van to open or close a passenger door without reaching their arm, hand, device or aperture outside the vehicle frame and body by opening and closing a side sliding vehicle door while in motion over all-terrains, including rough-terrains, even at accelerated speeds.

2. Description of Prior Art

Prior to now utility sport vehicle, and; or a van or truck with a similar vehicle front end or with a conical glare reducing hood, dash, and windshield like a mini van front end are unable to compete or demonstrate high-performance all-terrain maneuvers while opening and closing a side sliding door. Lack of an all-terrain suspension system and/or top heavy frames prevent vans from high-performance sport utility maneuvers and sport utility side hinge doors create aerodynamic and dynamic drag which all features inhibit being able to transport people, patients, children, animals and equipment through all-terrain conditions while at the same time operating pick-up, rescue and target pin-pointing, while in rapid motion or stopped, without leaving the confines of the vehicle.

### SUMMARY OF THE INVENTION

Inherently, I have invented the home utility management vehicle mini van or HUM V Mini Van, which is a utility vehicle, sport utility vehicle, truck, van passenger van or van with a mini van like frame and front end hood, dash and windshield featuring the unique construction of a sport utility chassis, bottom mounted scuff plate, side sliding door or doors configurations, uniquely capable of high-speed performance, off-road, rough-terrain transport, high, low, and level 360 degree motion-picture, picture-taking and surveillance maneuvering, with on-the-fly pick-up, rescues and other device manipulation capabilities, advantages and functions.

### BRIEF DESCRIPTION OF THE DRAWINGS

FIG. 1A is a side view of the home utility management vehicle mini van or HUM V Mini Van, traveling in rapid motion over an uneven and convex surface while a side sliding door in an open position allows a motion-picture camera to extend on a stable robotic arm for a level angle shot while in motion over the rough terrain and convex obstacles.

FIG. 1B (Amended) is a side view of the home utility management vehicle mini van or HUM V Mini Van, traveling in rapid motion over an uneven and convex surface while a side sliding door in an open position allows a motion-picture camera to extend on a stable robotic arm for a level angle shot while in motion over the rough terrain and convex obstacles.

### DETAILED DESCRIPTION OF THE INVENTION AND DRAWING

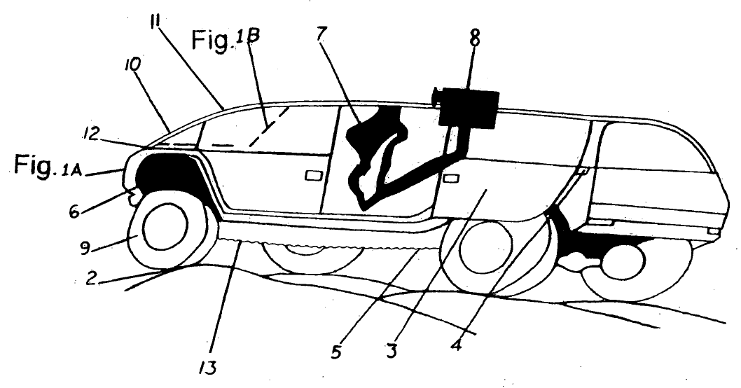

FIG. 1A depicts the home utility management vehicle mini van or HUM V Mini Van 1, accelerating over rough-terrain 2. A side sliding door 3, and partially concealed sliding door tack end 4, with sliding door in the open position on its runners, while the unique serrated bottom mounted scuff-plate surface 5, and large truck wheel wells for housing an all-terrain vehicle suspension 6, protect and enable the sport utility vehicle or van to off-road maneuver. A stable robotic arm 7, and motion-picture camera 8, are extending through the sliding door opening, allowing a driver of the HUM V SUV, HUM V Mini Van or home utility management vehicle mini van to shoot high, low or level angle pictures in motion over rough-terrain from a drivers seat. A set of all-terrain tires 9, support the utility vehicle. A single portion 10, and 11, of tempered glass forms the conical aerodynamic, glare reducing mini van front end cover hood and dash 12. A serrated bottom portion 13, bottom-mounted scuff-plate for shredding, crushing or shattering objects under the vehicle chassis. An alternate front end is shown constructed on the new vehicle by a broken line FIG. 1B, such as an old sport utility or truck might use.

1. The home utility management vehicle mini van or HUM V Mini Van where a van, passenger van, sport utility vehicle, truck or mini van are constructed with a side sliding door or doors, bottom mounted scuff-plate, sport utility chassis or truck or similar vehicle chassis, including a car vehicle chassis, truck or raised wheel wells for all-terrain wheel suspension and all-terrain tires.

2. The home utility management vehicle mini van or HUM V Mini Van where a van, passenger van, sport utility vehicle, truck or mini van are constructed with a side sliding door or doors, bottom mounted scuff-plate, sport utility chassis or truck or similar vehicle chassis, including a car vehicle chassis, truck or raised wheel wells for all-terrain wheel suspension and all-terrain tires, and a remote controlled side sliding door operable by the driver or other person while said vehicle is in motion over all-terrains, including rough and off-road terrains.

3. The home utility management vehicle mini van or HUM V Mini Van where a van, passenger van, sport utility vehicle, truck or mini van are constructed with a side sliding door or doors, bottom mounted scuff-plate, sport utility chassis or truck or similar vehicle chassis, including a car vehicle chassis, truck or raised wheel wells for all-terrain wheel suspension and all-terrain tires, with a remote controlled, handle or level operated side sliding door operable by the driver or other person while said vehicle is in motion over all-terrains, including rough and off-road terrains, and a stable robotic arm able to manipulate objects, subjects or a camera, including a 35 mm cameras, and motion-picture cameras or other camera, lens, emitting device, or other device or devices, able to complete functions at the said vehicle drivers or other persons commands by electronic or hand operated sequencing, including taking pictures or motion-pictures or transmitting or recording Television Broadcasts at high, low or level angles, aperture or functional degrees in a 360 degree area, while the said vehicle is in motion when said camera or device extends and then retracts through a side sliding door of said new utility vehicle.

4. (canceled)
